(19) United States
(12) Patent Application Publication
(10) Pub. No.: US 2024/0236383 A9
(43) Pub. Date: Jul. 11, 2024

(54) TRANSFERRING AND ACCESSING USER-SPECIFIC STORED CONTENT

(71) Applicant: Comcast Cable Communications, LLC, Philadelphia, PA (US)

(72) Inventor: Christopher LINTZ, Denver, CO (US)

(21) Appl. No.: 18/048,749

(22) Filed: Oct. 21, 2022

(51) Int. Cl. H04N 21/231; H04N 21/218

(52) U.S. Cl. CPC H04N 21/23116; H04N 21/2181

(57) ABSTRACT

Systems and methods are described herein for moving content across a network by replicating compressed video segments. Data transfer burdens on the network may be reduced by only moving residual data associated with an original segment (e.g., an original recording) across the network and using the residual data to recreate the original segment. According to some aspects, the original segment may be decoded from the residual with a private key.

### BACKGROUND

Many content providers (e.g., a cable service provider) offer cloud or network storage for content recording. For example, in a cloud or network digital video recorder (DVR) system, content may be recorded or stored on the provider's servers for the requesting user. Because individual users may select the same content to store (e.g., multiple users recording the same show), a particular stored recording file may be very similar or nearly identical to other stored recording files. Writing, accessing, storing, and/or delivering copies of similar stored content may use up significant computing resources. Accordingly, there is a need for more efficient techniques for, writing, accessing, storing, and/or delivering user-specific recorded content.

### SUMMARY

Systems and methods are described herein for storing, transferring, and accessing content by recreating the original content from a content segment group file. Stored content may include content recorded (e.g., in a cloud or DVR) by an individual user. Due to industry requirements, it may be necessary to store at least a portion of a user's recorded content individually and/or separately from other users' content (e.g., it may be necessary to store unique content associated with a unique user account). The content segments may include a user-specific content segment and a common content segment (e.g., residual). The user-specific content segment may be unique to a user and may be associated with a common content segment (e.g., residual) representing a portion of the recorded content that is the same for a particular stored recording for a plurality of users. The techniques described herein may determine whether any given content segment (e.g., a user recording) is more efficient to store and transfer by one or more of the following processes: (1) using a user-specific content segment (e.g., a unique portion of a user recording) and a common content segment (e.g., residual) to recreate (e.g., replicate) the content segment; or (2) to use a content segment group file to recreate the content segment. For example, a recording service may be queried for total recordings for the same program. If the aggregate size of the user-specific content segments is smaller than the residual size, then the original segment may be replicated using the residual. Otherwise, it may become increasingly more efficient to generate a common segment group file, e.g., combining the individual user-specific content segments into a single common segment group file.

The content segment group file may, for example, include an entirety of an original content (e.g., an entire show) and may split the original content into a number of equal common portions or “residuals” (e.g., a single one-hour recording split into two-second segments) and may include data usable to replicate the user-specific content segments. For example, rather than also storing each user-specific content segment individually, burdens on computing resources may be reduced by storing the content segment group file including the data usable to replicate the user-specific content segments. A header associated with the content segment group file may provide the data usable to replicate the user-specific content segments in order to satisfy a request from a user to playback their unique recording. For example, the provided data in the header may include a specific time to coordinate a user's recorded content segment with one or more content segments of the content segment group file.

### BRIEF DESCRIPTION OF THE DRAWINGS

The following drawings show generally, by way of example, but not by way of limitation, various examples discussed in the present disclosure. In the drawings:

FIG. 1 shows an example system;

FIG. 2 shows example user-specific content segments written into content segment group files;

FIG. 3 shows an example diagram of user-specific content segment aggregate size versus residual for various totals of a recorded program;

FIG. 4 shows an example residual header;

FIG. 5 shows an example system;

FIG. 6 shows an example data structure;

FIG. 7 shows an example method; and

FIG. 8 depicts an example computing device.

### DETAILED DESCRIPTION OF ILLUSTRATIVE EMBODIMENTS

Systems and methods are described herein for storing, transferring, and accessing stored content by recreating the content from a content segment group file. Stored content may include content recorded (e.g., in a cloud or DVR) by an individual user. Due to industry requirements, it may be necessary to store at least a portion of a user's recorded content individually and/or separately from other users' content (e.g., it may be necessary to store unique content associated with a unique user account). The content segments may include a user-specific content segment and a common content segment (e.g., residual). The user-specific content segment may be unique to a user and may be associated with a common content segment (e.g., residual) representing a portion of the recorded content that is the same for a particular stored recording for a plurality of users. In order to reduce data storage and data transfer burdens on the associated computing resources (e.g., network, data storage, processing, etc.), storing recorded content for a particular user would include storing the user-specific content along with the common (e.g., residual) content file that represents the portion of content common to the users that recorded that same content.

The user-specific content segment may, for example, be associated with a specific user account or account number. The common content segment (e.g., residual) may be associated with a particular stored recording (e.g., not with any specific user). For example, when a user requests to view their previously recorded content, the content may be returned (e.g., “replicated”) by combining the user-specific content segment with the residual. Hence, burdens on associated computing resources may be relieved because individually storing the user-specific content segments and the common residual portion eliminates the need to store redundant copies of the full content segment. The quantity of user-specific content segments stored in the system may vary based on the number and/or size of recordings of similar content.

As a number of copies of user-specific content segments increases and the file volume of user-specific content segments increases, burdens on associated computing resources increase (e.g., based on limited storage space and/or frequent read-write operations associated with replication jobs). These burdens on the associated computing resources (e.g., processors and/or data storage devices) may be reduced by reducing the total storage size and/or read-write operations associated with the user-specific content segments. In accordance with the techniques described herein, rather than storing the user-specific content segments individually as described above (e.g., in a concatenated user-specific content segment file), a content segment group file may be generated and used to recreate (e.g., “replicate”) the recorded content.

The content segment group file may, for example, include an entirety of an original content (e.g., an entire show) and may split the original content into a number of equal common portions or “residuals” (e.g., a single one-hour recording split into two-second segments) and may include data usable to replicate the user-specific content segments. For example, rather than also storing each user-specific content segment individually, burdens on computing resources may be reduced by storing the content segment group file including the data usable to replicate the user-specific content segments. A header associated with the content segment group file may provide the data usable to replicate the user-specific content segments in order to satisfy a request from a user to playback their unique recording. For example, the provided data in the header may include a specific time to coordinate a user's recorded content segment with one or more content segments of the content segment group file.

Data transfer burdens on the network may be reduced by moving residual data (e.g., common segments from a content segment group file) associated with an original segment (e.g., an original recording) across the network and using the residual data to recreate the original segment. The content segment group file may be encrypted and, the common segment(s) may be decoded from the residual with a private key (e.g., satisfying requirements for individualized user storage).

The content segment group file may be associated with a header. The header may contain information representing a unique recording. For example, the header and/or any information associated with the header may be encrypted. For example, the header and/or information associated with the header may be symmetrically encrypted, e.g., using the same key for both encryption and decryption. The information may be used for the purpose of redundancy and/or transfer across a network. A private key may be used to decrypt the information stored within the header. Moreover, industry requirements may be satisfied by one or more of including user specific information in the header, including unique recording information in the header, and/or encrypting one or more portions of the header.

Systems and methods may determine whether any given segment (e.g., recording) is more efficient to transfer by the content segment group file or by using a user-specific content segment and a residual to form an original segment. For example, a recording service may be queried for a total number of recordings for the same program. If the aggregate size of the user-specific content segments is smaller than the residual size, then the original segment may be replicated using the user-specific content segments and the residual. Otherwise, a content segment group file may be generated and used to replicate the recordings of the program thereby more efficiently using of the associated computing resources (e.g., network, data storage, processing, etc.).

Replication based on the original segment may be achieved through instructions contained in a replication job. Residual metadata associated with a content segment may be stored in or associated with (e.g., in quick access memory) a user profile. The residual metadata may be used to identify, store, access, and/or replicate any content segments associated with a given user. For example, a user profile may include unique information regarding the user and any associated user-specific content segments and/or content-segment group files. The residual metadata associated with a user profile may be stored in, for example, quick-access memory optimized for input output processor (TOP) read/writes. Using the residual metadata eliminates the need to read or transfer user-specific content segments for replication.

A content generator may receive a replication job associated with a content item and may encode the content item into a plurality of content segments (e.g., content segments may be of uniform size and/or length). The content generator may output and/or store the plurality of content segments as a content segment group file. The content segment group file may be created from one or more user-specific content segment files. For example, the user-specific content segment file(s) may be copied at the destination through a set of replication instructions (e.g., in a replication job). For example, the content generator may utilize an original segment that is derived from the one or more user-specific content segment files and residual data to generate a content segment group file. Metadata may be transferred across the network along with the original segment to a receiving process, which may generate the content segment group file.

Information (e.g., symmetrically encrypted coordination information) may be included in a header and an original segment may be decoded (e.g., with a private key) from the residuals of the content segment group file. According to some aspects, the information may include information needed to replicate a requested content segment from a content segment group file (e.g., content identifier(s), timing information, user information, etc.). Moreover, the information may be dedicated for replication purposes only (e.g., in no way associated with any customer user-specific content segment).

The content segment group file may be much smaller than a concatenated user-specific content segment file. For example, if a large number of users have recorded a particular program, a concatenated user-specific content segment file may be larger than the entirety of the particular program. In such a case, it may be more efficient to generate a content segment group file comprising an entirety of the program (e.g., split into equal size segments or “residuals”).

Moreover, it may be unnecessary to read or transfer any user-specific content segments for replication (e.g., only residuals from a content segment group file). For example, information from a header associated with a replication request may be used to recreate a user-specific content segment from a content segment group file. Moreover, coalescing of unique recordings and their relationship to residuals may keep the residual bytes read from storage small and the replication job that is transferred across the network an optimal size. The payload may account for overlapping recordings (e.g., different start/end times).

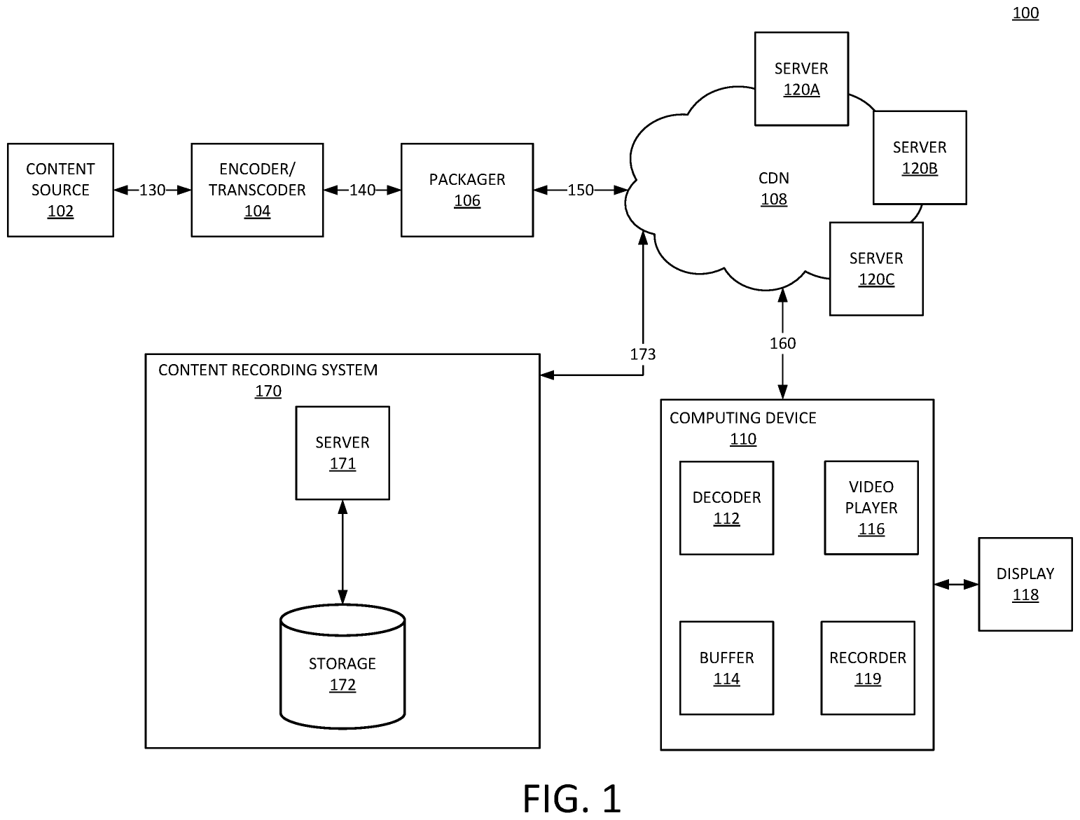

FIG. 1 shows system 100 for delivering content. The example system 100 may comprise a content source 102, an encoder/transcoder 104, a packager 101, a content delivery network (CDN) 108, and a computing device 110. The techniques for video processing described herein are applicable to any content delivery method including but not limited to Dynamic Adaptive Streaming over HTTP (DASH), HTTP Live Streaming (HLS), the quadrature amplitude modulation (QAM) standard, and/or adaptive bit rate (ABR) streaming.

The computing device 110 may comprise a television, a monitor, a laptop, a desktop, a smart phone, a set-top box, a streaming-video player, a cable modem, a gateway, a tablet, a wearable computing device, a mobile computing device, any computing device configured to receive and/or render content, the like, and/or any combination of the foregoing. The computing device 110 may comprise a decoder 112, a buffer 114, a video player 116, and a digital video recorder (DVR) 119. The computing device 110 (e.g., the video player 116) may be communicatively connected to a display 118. The display 118 may be a separate and discrete component from the computing device 110, such as a television display connected to a set-top box. The display 118 may be integrated with the computing device 110. The decoder 112, the video player 116, the buffer 114, the DVR 119, and the display 118 may be realized in a single device, such as a laptop or mobile device. The decoder 112 may decompress/decode encoded video data. The encoded video data may be received from the encoder/transcoder 104, the packager 106, or the CDN 108.

The content source 102 may comprise a source feed of content from a provider. For example, the content source 102 may comprise a broadcast source, a service provider (e.g., a cable television service provider), a headend, a video on-demand server, a cable modem termination system, the like, and/or any combination of the foregoing. The content source 102 may send content 130 to the encoder/transcoder 104. The content 130 may comprise for example, a program, a television show, a movie, a sports event broadcast, or the like. The content 130 may comprise video frames or other images. For example, the content 130 may comprise video frames in a Moving Picture Experts Group (MPEG) Single Program Transport Stream (MPEG-SPTS). The video frames may comprise pixels. A pixel may comprise the smallest controllable element of a video frame. The video frame may comprise bits for controlling each associated pixel. A portion of the bits for an associated pixel may control a luma value (e.g., light intensity) of each associated pixel. A portion of the bits for an associated pixel may control one or more chrominance value (e.g., color) of the pixel.

The content source 102 may receive requests for the content 130 from the encoder/transcoder 104, the packager 106, the computing device 110, or the CDN 108. The content source 102 may send content 130 to the encoder/transcoder 104 based on a request for video from the encoder/transcoder 104, the packager 106, the computing device 110, or the CDN 108. The content 130 may comprise uncompressed video data or a content stream such as an MPEG-SPTS.

The encoder/transcoder 104 may comprise an encoder, which may encode uncompressed video data received from the content source 102. The terms transcoder and encoder may be used interchangeably herein. The terms transcode and encode may be used interchangeably herein. The encoder/trans coder 104 may receive content from the content source 102. The content may be in any one of a variety of formats, such as, for example, H.264, MPEG-4 Part 2, or MPEG-2. The encoder/transcoder 104 may convert the content from one video format to another video format, such as one format compatible with the playback devices of the service provider's users (e.g., computing device 110). The encoder/transcoder 104 may additionally segment the content into a plurality of segments. For example, content may be segmented into a series of 2-second segments.

When uncompressed video data is received, the encoder may encode the video (e.g., into a compressed format) using a compression technique prior to transmission. The content source 102 and the encoder/transcoder 104 may be co-located at a premises, located at separate premises, or associated with separate instances in the cloud. The encoder 104 may comprise any type of encoder including but not limited to: H.264/MPEG-AVC, H.265/MPEG-HEVC, MPEG-5 EVC, H.266/MPEG-VVC, AV1, VP9, Global motion compensation (GMC), etc. The encoder/transcoder 104 may transcode the content 130 into one or more output streams 140. The one or more output streams 140 may comprise video encoded with different resolutions and/or different bit rates.

The packager 106 may receive the content from the encoder/transcoder 104 or the content recording system 170. For example, the packager 106 may receive the one or more output streams 140 from the encoder/transcoder 104. The packager 106 may determine how the content is to be segmented and put together for delivery to and eventual playback by the computing device 110. As part of this process, the packager 106 may segment the content (such as in the event that the content has not yet been segmented) or may re-segment the content (such as in the event that the content had been previously segmented). The packager 106 may additionally insert one or more cues or markers into the content segments at which one or more additional segments, such as segments comprising an advertisement, may be inserted by an upstream client, server, or logical module, such as the computing device 132 or the server 171.

The packager 106 may create a manifest file associated with the content. For example, the manifest may comprise a DASH manifest. The manifest may comprise information describing various aspects of the associated content that may be useful for the computing device 110 to playback the content and/or for the content recording system 170 to store and retrieve the content. For example, the manifest may indicate the availability of the segments comprising the content, the length of each segment, the number of segments, and/or the proper ordering of the segments necessary to cause playback of the content. The manifest may further include a network location (e.g., a hyper-text transfer protocol (HTTP) uniform resource locater (URL) link or other universal resource identifier (URI)) for each segment from which the segment may be downloaded, accessed, or retrieved. For example, the network location may indicate a location in storage 172.

The packager 106 may generate one or more ABR streams 150 in different ABR streaming formats. The one or more ABR streams 150 may comprise segments or fragments of video and the manifest. The manifest may indicate availability of the ABR stream and segments/fragments and information for requesting the segments/fragments (e.g., via a URL). The packager 106 may send the one or more ABR streams 150 to the CDN 108.

The CDN 108 may comprise one or more computing devices such as servers 120A, 120B, 120C that store content (e.g., the one or more ABR streams 150). The CDN 108 may receive a request for content from the computing device 110. The request may be sent via HTTP. The CDN 108 may authorize/authenticate the request and/or the computing device 110 from which the request originated. The request for content may comprise a request for a channel, a recorded program, a video on-demand asset, a website address, a video asset associated with a streaming service, the like, and/or any combination of the foregoing. The CDN 108 may send the request to the content source 102, the encoder/transcoder 104, or the packager 106. The CDN 108 may send the requested content 160 to the computing device 110. The one or more servers 120A, 120B, 120C of the CDN 108 may serve the content 160 to the computing device 110.

The system 100 may comprise the content recording system 170 such as a cloud or DVR system, by which the content source 102 may receive a request to record content 173, store the recorded content 173, and potentially fulfill a request to deliver the recorded content 173 for playback. The request to record content may be received from the computing device 110, and the requested content may be delivered to the computing device 110 for playback. The content recording system 170 may include server 171. The server 171 may receive and fulfill a request from the computing device 110 to deliver recorded content to the computing device 110 for playback. The request from the computing device 110 to deliver the recorded content may include identifications of the user (e.g., an account identifier, a username and/or a password), the computing device 110, the requested content, and/or a playback time point or temporal location (e.g., the start of a program or the 12:30 mark in a 30:00 program). The request to deliver the content may indicate a user requesting to skip to a particular portion of content of which the initial segments of the content have already been delivered and are being played on the computing device 110. For example, a user may have started viewing the first minute of content and may then decide to skip to a midway point of the content. In this case, the request to deliver the content would indicate that the computing device 110 is requesting the segments of the content from that midway point and after.

Upon receiving a request to deliver stored content to the computing device 110, the server 171 may provide one or more manifest files to the computing device 110 that describe the content and segments thereof, including network locations from which each segment may be downloaded. Using the manifest file, the computing device 110 may download the segments comprising the content. As the computing device 110 downloads sufficient segments of the content, the computing device 132 may begin playback of the content.

The stored content or portions thereof may be stored in the storage 172, which may be accessed by the computing device 110 directly or indirectly via the server 171 to deliver the stored content to the computing device 110. The storage of the content or portions thereof may occur after the packager 106 processes the content. The storage 172 may comprise cloud object storage and/or one or more data storage devices, such as volatile memory (e.g., one or more of random access memory (RAM)), a hard disk drive, a network-attached storage (NAS), a storage area network (SAN), SATA drive, a solid state drive (SSD), or a non-volatile memory express (NVMe) drive upon which the content or portions thereof may be stored.

In some aspects, the stored content segments may comprise user-specific content segments and common segments. The user-specific content segments may small portions of a bitstream associated with the content. For example, a user-specific content segment may comprise a portion of content (e.g., a 2-second chunk of content). The user-specific content segments may be limited to a user account. The common content may comprise the remaining concatenated portions of the bitstream and may be accessible by a plurality of users (e.g., by a plurality of user accounts). The content (e.g., a recorded channel or program) may be stored as a single common portion (e.g., comprising a plurality of common segments) and corresponding user-specific portions (e.g., for each user storing the content). The common portions are unplayable without the user-specific portions. For example, a unique recording may be associated with, for example, a recording requested by the computing device 110. The representation of the unique recording may comprise a portion (e.g., 1%) of the total recorded content segment and may be associated with a profile of the user associated with the computing device 110. The common portion may comprise the remaining portion (e.g., 99%) and be common to multiple computing devices. For example, the computing device 110 may request to record a particular program that is also being recorded for other computing devices.

A content segment grouping may comprise a storage container that comprises a header and multiple concatenated content segments for a representation of a unique recording. One or more content segment groupings may be associated with the unique portion of the recording for the computing device 110. A common portion of the content may be stored for each of the computing devices. The user-specific storage may comprise information (e.g., index files) to allow for the location and reconstitution of the content based on the user-specific portion, the common portion, the header data, and/or the like.

Large-scale cloud DVR (e.g., associated with a cable company or content provider) may generate a large number of bytes of disk for unique recordings. Compression techniques may reduce bytes on disk significantly. Moreover, leaving unique content at-rest (e.g., compared to duplication via archiving) may also decrease bytes on disk and increase storage capacity. For example, a content section may be subdivided in a user-specific portion and a common portion (e.g., a residual portion). Different versions and/or copies of the user-specific portion may be stored in corresponding user-specific storage for different user accounts. The common portion may be stored in common storage. The common storage may be independent from each of the user-specific storages. If playback of a content section is requested, then the user-specific portion associated with the requesting user account may be recombined with the corresponding common portion. The combined user-specific portion and common portion may be decoded to form the original playable content segment.

Cloud storage may utilize serial advanced technology attachment (SATA) drives in a single private object storage system. As a result, a bottleneck may be experienced based on a high number of IOPS (input/output operations) but not based on capacity issues. This bottleneck may require an oversized object store just to accommodate the high number IOP bursts observed, for example, at peak recording and playback times. Hybrid storage solutions may facilitate optimization of the IOP read/writes of active recordings and playback by maintaining unique segments in a solid state drive (SSD)/NVMe (nonvolatile memory express) storage (e.g., “hot storage”). Content segments per unique recording and per representation may be concatenated into content segment group files as the recording is in progress. A content segment group file may contain a header that includes information including one or more of content segment size, ticks per second, and total content segments. A playback request for recorded content may be satisfied by the metadata in the header.

The “hot” storage may be associated with very fast access and may be located close in physical and/or virtual proximity to users (e.g., storing or accessing content). Hot storage may come at a higher cost and examples of hot storage may include solid state drives, flash drives, etc. “Cold” storage, on the other hand, may be associated with lower access speeds and may be located farther away from users than hot storage (e.g., on a remote server or in a cloud service). Cold storage may be less costly than hot storage and examples of cold storage may include spinning drives, cloud drives, etc. Content may stay at rest in hot storage for a time period (e.g., three days). An auto-storage process may content segments (e.g., content segment group files) from hot storage to cold storage (e.g., a spinning disk, scaled for capacity) based on, for example, age since written or by last access time (e.g., some delay after playback). This delay of the time period may take advantage of playbacks and deletes that occur in hot storage (e.g., applicable to approximately 40% of the content). For example, as more content is deleted in the hot storage, less bytes need to be transferred to the cold storage. Moreover, economies of scale may be achieved both by IOPS (input/output operations per second) in the hot storage (e.g., scaled for a high number IOPS) and capacity in the cold storage (e.g., scaled for large capacity).

Rather than storing individual user-specific content segment files (e.g., in a concatenated storage format), in accordance with the techniques described herein, content may be replicated from a content segment group file at the destination through a set of replication instructions in a replication process. The replication process may utilize only the original segment, recording metadata, and the content segment group file. Recording metadata may be transferred across the network (e.g., in a header and/or a user profile) to a receiving process. The receiving process may generate the content locally using the content segment group file and encrypted information.

For example, an instruction set with a recording identifier may be used to create a content segment group file (e.g., comprising a number N of content segments) associated with the recording identifier. When a number of stored user-specific content segments associated with the recording identifier exceeds a threshold (e.g., N), a single concatenated user-specific content segment group file may be generated from the original content segment associated with the recording identifier by looping N times over the original content segment. At the end of each iteration the last segment may be concatenated to the previous concatenated segments. At the end of the loop a single concatenated group file may be written to storage. Instruction sets associated with the concatenated group file may contain one or more recording identifiers and one or more representations (e.g., associated with one or more user-specific content segments).

According to some aspects, it may be determined whether any given segment (e.g., recording) is more efficient to transfer by concatenated user-specific content portions or by using a residual to form an original segment (e.g., a content segment group file). A content segment group file may, for example, include an entirety of an original content (e.g., an entire show) and may split the original content into a number of equal common portions or “residuals” (e.g., a single one-hour recording split into two-second segments). Rather than store each user-specific content segment individually, burdens on computing resources may be reduced by storing only the content segment group file. A header associated with the content segment group file may provide data to satisfy a request for the user-specific content segment. For example, the provided data in the header may include a specific time to coordinate a user's recorded content segment with one or more content segments of the content segment group file.

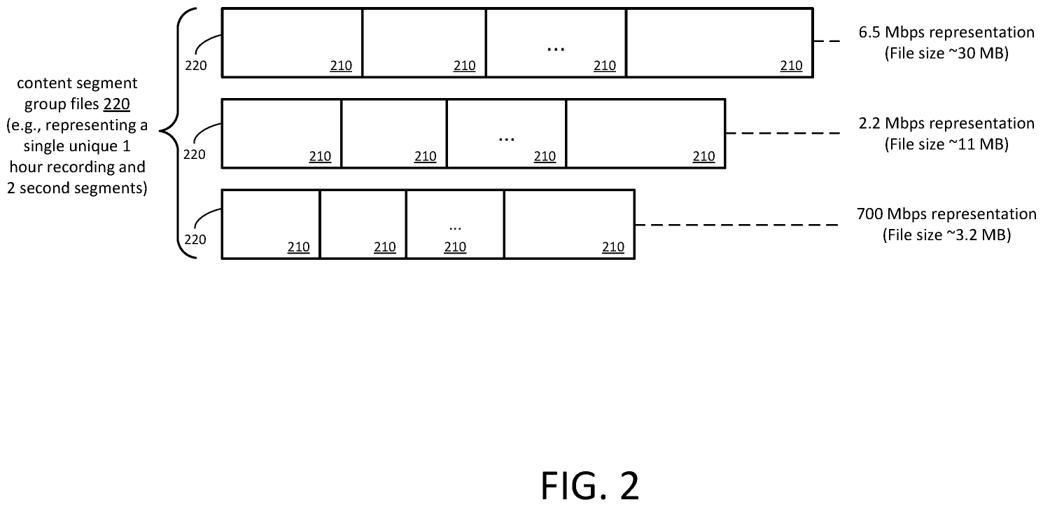

FIG. 2 shows an example of content segment group files 200. Each content segment group file may comprise a plurality of content segments, e.g., concatenated into content segment group files 220 as the recording is in progress. For example, FIG. 2 illustrates record-time concatenated content segments 210 sequentially written into content segment group files 220. Each content segment group file 220 contains a header that includes information, including on or more of size, ticks per second, and/or total content segments. According to some aspects, this header provides enough metadata to satisfy a playback request. The metadata may be used (e.g., based on a playback request) to identify the specific content segments 210 of a specific content segment group file 220 to replicate the content associated with the playback request.

When transferring content segment group files 220, each file may be read from the hot storage (e.g., consuming a large amount IOPS), and the bytes read may be transferred across multiple networks in order to write into a cold storage. Moreover, replicating video content can be an expensive operation from a storage system perspective. The large number of bytes transferred over the network also may require a substantial transfer rate to move a large amount of content (e.g., recordings of a day's worth of content). For example, 600 terabytes (TB) may have an average transfer rate (e.g., from the hot storage to the cold storage) of 74 Gbit within an 18-hour time window. As illustrated in FIG. 2, the content segment group files 220 may be based on quality and/or size. For example, a 6.5 Mbps representation of the content may have a higher quality and larger storage size than a 2.2 Mbps representation of the content. Similarly, a 2.2 Mbps representation of the content may have a higher quality and larger storage size than a 700 Mbps representation of the content. Moreover, the content segments 210 associated with the content segment group files 220 may vary in size based on the size or quality associated with the content segment group file 220.

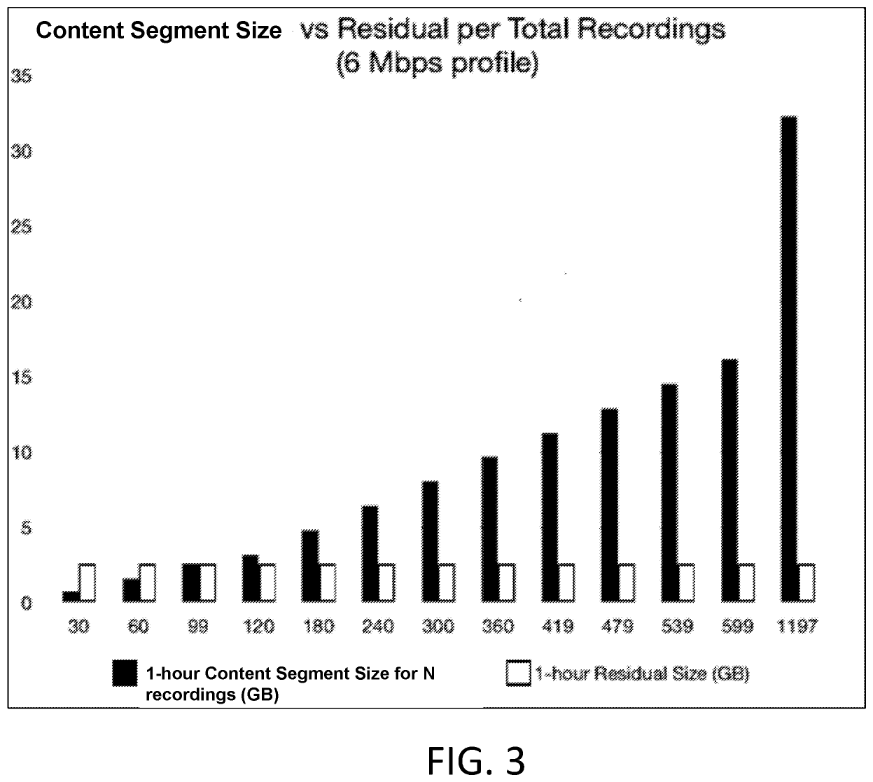

FIG. 3 shows an example of recording data. As illustrated in the example of FIG. 3, as a number of total recordings increases, the user-specific content segment aggregate size may also increase. Because the user specific content segment is much smaller than the common content segment (the “residual”), a number of user-specific content segments must exceed a threshold number for the total size of the cumulative user-specific content segments to exceed the size of the residual. The residual size is unaffected (e.g., remains constant) as the number of total recording increases because the residual is the common portion of the recording. Thus, it may become increasingly more efficient to replicate via residual (e.g., a content segment group file) rather than via each unique user-specific content segment, e.g., less read IOPS/bytes and cross network throughput. In order to achieve more efficiency in replicating content, it may be determined to transfer recordings by (1) user-specific content segments or by (2) content segment group files using residual data and forming the original segment for N recordings (e.g., same program recordings).

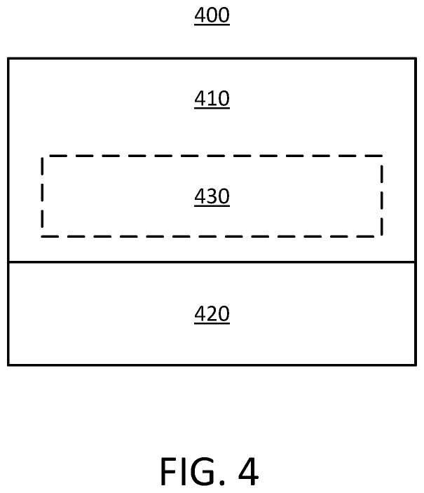

A residual header (e.g., header associated with a content segment group file) may contain one or more encrypted (e.g., symmetrically by using the same key to both encrypt and decrypt data) portions. FIG. 4 shows an example residual header 410. As illustrated in FIG. 4, the residual header 410 may be added to a header structure representing a content segment group file 400. According to some aspects, a private key may be used to decrypt the header 410 and/or one or more segments 420 of the content segment group file 400. The header 410 may comprise information 430 (e.g., size, ticks per second, and/or total content segments). For example, the information 430 may include a specific time to coordinate a user's recorded content segment with one or more content segments of the content segment group file 400. Moreover, the header 410 may include an internal account of the unique recordings associated with a content segment group file 420. Based on the aggregate size of the total recordings in relation to the residual size, it may be determined whether it is more efficient to move the user specific content segments through the system or to use the content segment group file 420 (e.g., move the residual).

According to some aspects, the original content may be decoded from the residual by using the private key to decrypt the content segment group file. For example, the encrypted content segment group file (e.g., 32 bytes) may include an internally created content segment, e.g., dedicated for replication purposes only and/or unassociated with any customer user-specific content segments). For example, the internally created content segment may provide security to the content segment group file based on a symmetrical encryption (e.g., where the same key is used to both encrypt and decrypt the internally created content segment).

For example, rather than reading all unique concatenated user-specific content segment files that have not been deleted, a residual-metadata file may be stored next to each unique per profile content segment group file. The residual metadata file may exist for each representation of a recording and may contain sequential residual file information that represents the sequential content segments contained in the content segment group file.

For example, the residual metadata file may utilize the following format:

```
/{streamid}/{createdTime}/{recordingid}/{representation}/{ContentSegment
GroupFile}
/{streamid}/{createdTime}/{recordingid}/{representation}/residual-meta
  VaultA
  /r1.gres
  /r2.gres
  ...
  /r1800.gres
```

The residual-metadata file may be much smaller than a concatenated user-specific content segment file resulting in lower transfer rates and requiring less storage capacity. For example, a binary or compressed residual data file may be less than 5 KB, whereas a one hour low-bitrate concatenated user-specific content segment file may be 7 MB, and a one hour high-bitrate content segment group file may be 16 MB. For example, the residual metadata file may be queried from the database that holds all recording and segment information. For example, an independent storage system may be responsible for replication without access to the database.

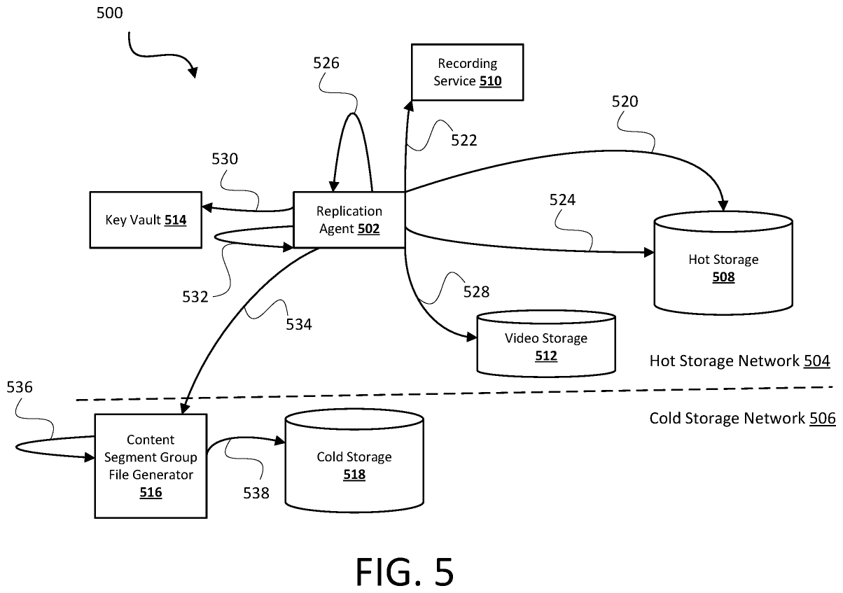

FIG. 5 shows an example system 500. The system 500 may be used to replicate content through a set of instructions contained in a replication job. A replication agent 502 of system 500 may communicate with one or more of a hot storage network 504 and a cold storage network 506. The hot storage network 504 may include one or more of the replication agent 502, hot storage 508, recording service 510, video storage 512, or a key vault 514. The cold storage network 506 may include one or more of a user-specific content segment generator 516 or cold storage 518.

The replication agent 502 may, for each unique content stream being recorded by the user (e.g., a content stream associated with a stream identifier or streamID), receive 520 a unique recording (e.g., a recording associated with one or more recording identifiers or recordingIDs) from the hot storage 508. The recordings associated with the recordingIDs may be limited to a specific time period. For example, it may be determined that the current time associated with the recordingIDs minus a created time (e.g., or a last accessed time) is greater than or equal to a maximum duration time. By limiting the time period, the system 500 may ensure that only recent recordings are stored in the hot storage 508. For example, recordings that are older than the specified time period may be moved to cold storage 518.

The replication agent 502 may determine 522, based on information from the recording service 510, a total number of active recordings for each recording identifier (e.g., or same program). Based on the total number of active recordings for each recording identifier, the replication agent 502 may compare a cumulative size of user-specific content segments to the size of the residual (e.g., common segment). If the cumulative size of the user-specific content segments exceeds the size of the residual, the replication agent may determine to generate a content segment group file (e.g., having a same or similar size as the residual). For example, at 522 the replication agent 502 may determine it is more efficient to move the user-specific content segment (e.g., due to a small total number of active recordings) than it is to use the residual to recreate the user-specific content segment (e.g., using the residual header with the encrypted system-specific content segment). On the other hand, at 522 the replication agent 502 may determine it is not more efficient to move the user-specific content segment (e.g., due to a large total number of active recordings) than it is to use the residual to recreate the user-specific content segment (e.g., using the residual header with a content segment group file). The replication agent 502 may receive 524 residual data from the hot storage 508 for each recording to be moved by residual (e.g., content segment group file). The replication agent 502 may coalesce 526 the recording IDs and the residuals. For example, the replication agent 502 may identify (e.g., based on metadata of the residual) which recordings share the same residual. For example, the following results may be coalesced for a recording group:
Recording Group
rec22, rec23, recY->r123.gres, r124, gres . . . rN.gres
rec85, rec86, recT->r521.gres, r522.gres . . . rZ.gres

The replication agent 502 may determine 528, from video storage 512, a number of residuals to fetch (e.g., based on a maximum transfer payload). The replication agent 502 may then retrieve each residual (e.g., for each recording group determined in step 526) and create a replication job.

For example, the replication job may be a compact data structure. Moreover, the replication job may comprise any compact binary protocol or text with segment bytes encoded in base64, as one example. Below is a Golang struct definition describing the replication job:

```
type Recording struct {
  RecordingID string
  SegmentIndexes[ ] int
}
type ReplicaInstruction struct {
  RawVideoSegments [ ]byte
  Representation uint32
  StreamID uint64
  Recording [ ]Recording
  CreatedTime uint64
}
type ReplicationJob struct {
  InstructionSet [ ]ReplicaInstruction
}
```

The replication agent 502 may determine 530, from key vault 514, a private key for each streamId. The replication agent 502 may use 532 the private key to decrypt the user-specific content segment in each residual header and decode each original video segment and add sequential video segments to a replication job for the recording group(s).

The replication agent 502 may send 534 the replication job to the content segment group file generator 516. According to some aspects, the content segment group file generator 516 may receive replication jobs and encode the segments to a unique content segment group file for each recording. The content segment group file generator 516 may output content segment group files and store them on cold storage 518. According to some aspects, if cold storage 518 is the last destination of the content, residual metadata files may not need to be generated (e.g., the recording system may maintain residual file locations). According to some aspects, exact copy residual metadata files from the hot storage 508 may be created if there is intent to replicate to another storage system. The content segment group file generator 516 may, for each recordingID, encode 536 (e.g., sequentially or in parallel) each content segment. The content segment group file generator 516 may, for each recordingID, write 538 a content segment group file to the cold storage 518.

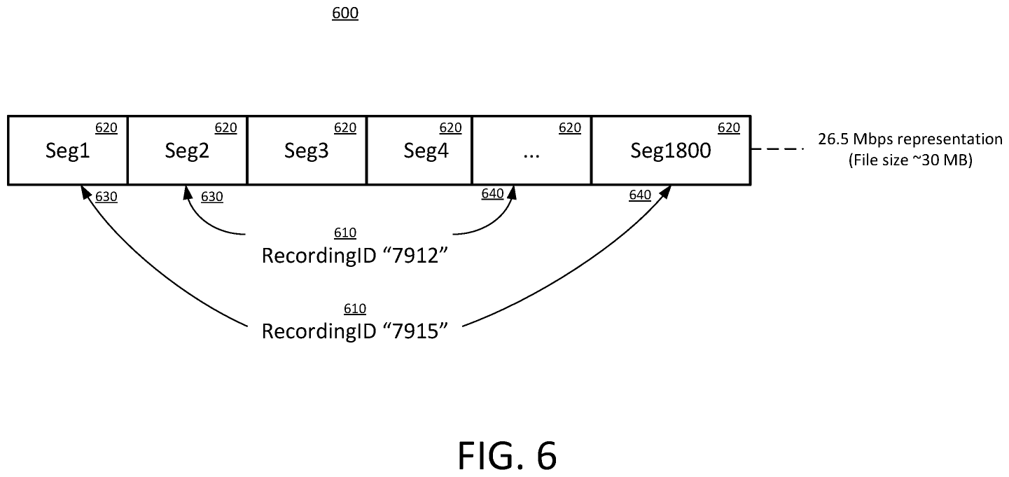

According to some aspects, the replication process data structure (e.g., StreamRecordings data structure) may support recordings that start and end at different times on a given stream and representation. Moreover, by utilizing the array of segments shown in FIG. 6, the replication process may recreate recorded content for one or more users (e.g., from a same content segment group file) where the recorded content started and/or stopped at different times. For example, the segments in the replication process data structure (e.g., content segment group file) may represent a full window of recordings on the replication job, e.g., some recordings may start early, some may start late. The array of segment (e.g., SegmentIndexes array) on each recording may have different windows of the sequential segments on the given stream and representation. For example, FIG. 6 illustrates a logical view of StreamRecordings 600 showing 2 recordings 610 with different SegmentIndexes 620 resulting in different start segments 630 and end segments 640.

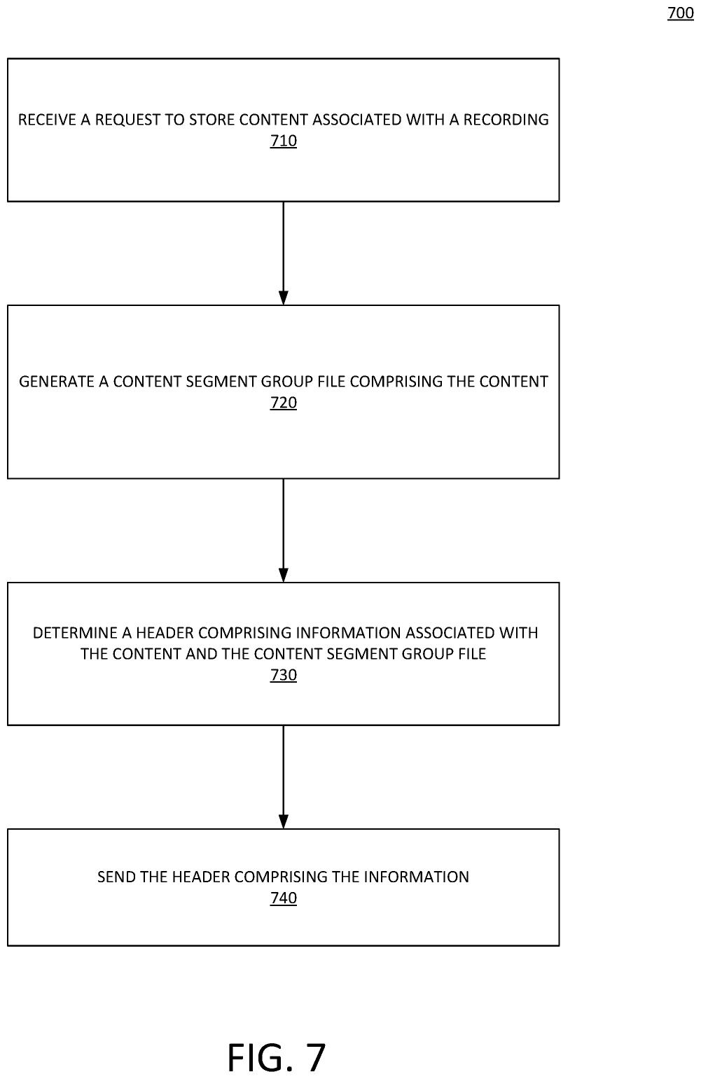

FIG. 7 shows an example method 700. The method 700 of FIG. 7 may be performed by any of the devices described herein. While each step in the method 700 of FIG. 7 is shown and described separately, multiple steps may be executed in a different order than what is shown, in parallel with each other, or concurrently with each other.

At step 710, a request may be received to store content associated with a recording. For example, the request may be received by a content segment group file generator from a replication agent. According to some aspects, the request may include a recording identifier. The recording may be unique to a user.

At step 720, a content segment group file comprising the content may be generated. For example, the content segment group file may be generated by the user-specific content segment generator. The content segment group file may comprise a plurality of uniform content segments. According to some aspects, the content segment group file may be generated based on determining an aggregate size of a plurality of user-specific content segment files associated with the recording exceeds a size of a residual (e.g., common segment group file) associated with the recording. A private or public key may be used to encrypt one or more segments of the content segment group file.

At step 730, a header comprising information coordinating the content and the content segment group file may be determined (e.g., by the content segment group file generator). For example, the header may include residual metadata associated with a user profile. Moreover, the header may be used to coalesce a unique recording and a relationship to a residual recording (e.g., common segment group file). Moreover, the residual recording may be common to a plurality of users comprising the user and the information included in the header may be used to replicate the recording that is specific to the user. For example, the header may include information including one or more of content segment size, ticks per second, and total content segments. Moreover, one or more aspects of the header may be encrypted (e.g., symmetrically).

A step 740, the header comprising the information coordinating the content and the content segment group file may be sent (e.g., by the content segment group file generator). For example, the content segment group file may be sent to a cold storage system and/or the header may be sent to a hot storage system. At a later point in time, a request for the recording may be received from a computing device associated with a user and playback of the recording may be caused based on the request. The request may include the header and, based on the information included in the header, the recording may be replicated from the content segments included in the content segment group file.

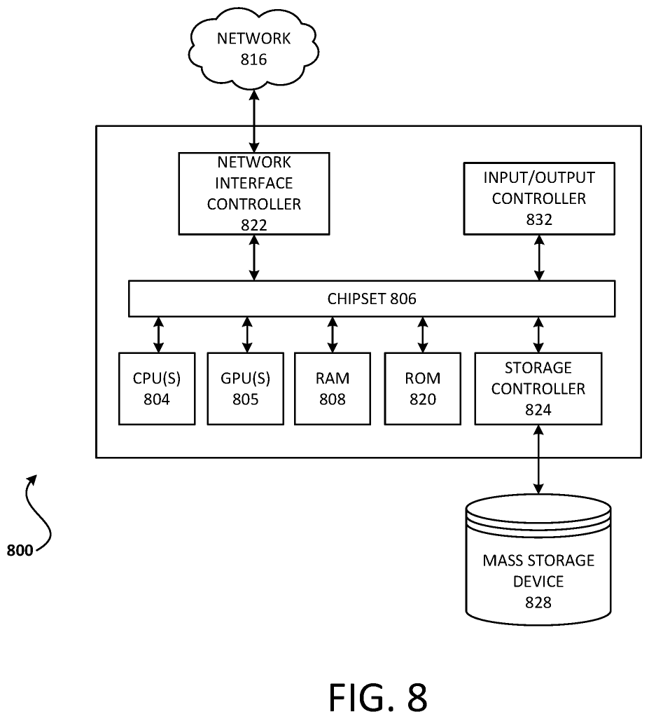

FIG. 8 depicts a computing device 800 that may be used in various aspects, such as the servers, encoders, computing device, and other devices depicted in FIGS. 1 and 5. With regard to the example architectures of FIGS. 1 and 5, the devices may each be implemented in an instance of a computing device 800 of FIG. 8. The computer architecture shown in FIG. 8 shows a conventional server computer, workstation, desktop computer, laptop, tablet, network appliance, PDA, e-reader, digital cellular phone, or other computing node, and may be utilized to execute any aspects of the computers described herein, such as to implement the methods described in relation to FIGS. 5 and 7.

The computing device 800 may include a baseboard, or “motherboard,” which is a printed circuit board to which a multitude of components or devices may be connected by way of a system bus or other electrical communication paths. One or more central processing units (CPUs) 804 may operate in conjunction with a chipset 806. The CPU(s) 804 may be standard programmable processors that perform arithmetic and logical operations necessary for the operation of the computing device 800.

The CPU(s) 804 may perform the necessary operations by transitioning from one discrete physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits including registers, adders-subtractors, arithmetic logic units, floating-point units, and the like.

The CPU(s) 804 may be augmented with or replaced by other processing units, such as GPU(s) 805. The GPU(s) 805 may comprise processing units specialized for but not necessarily limited to highly parallel computations, such as graphics and other visualization-related processing.

A chipset 806 may provide an interface between the CPU(s) 804 and the remainder of the components and devices on the baseboard. The chipset 806 may provide an interface to a random access memory (RAM) 808 used as the main memory in the computing device 800. The chipset 806 may further provide an interface to a computer-readable storage medium, such as a read-only memory (ROM) 820 or non-volatile RAM (NVRAM) (not shown), for storing basic routines that may help to start up the computing device 800 and to transfer information between the various components and devices. ROM 820 or NVRAM may also store other software components necessary for the operation of the computing device 800 in accordance with the aspects described herein.

The computing device 800 may operate in a networked environment using logical connections to remote computing nodes and computer systems through local area network (LAN) 816. The chipset 806 may include functionality for providing network connectivity through a network interface controller (NIC) 822, such as a gigabit Ethernet adapter. A NIC 822 may be capable of connecting the computing device 800 to other computing nodes over a network 816. It should be appreciated that multiple NICs 822 may be present in the computing device 800, connecting the computing device to other types of networks and remote computer systems.

The computing device 800 may be connected to a mass storage device 828 that provides non-volatile storage for the computer. The mass storage device 828 may store system programs, application programs, other program modules, and data, which have been described in greater detail herein. The mass storage device 828 may be connected to the computing device 800 through a storage controller 824 connected to the chipset 806. The mass storage device 828 may consist of one or more physical storage units. A storage controller 824 may interface with the physical storage units through a serial attached SCSI (SAS) interface, a SATA interface, a fiber channel (FC) interface, or other type of interface for physically connecting and transferring data between computers and physical storage units.

The computing device 800 may store data on a mass storage device 828 by transforming the physical state of the physical storage units to reflect the information being stored. The specific transformation of a physical state may depend on various factors and on different implementations of this description. Examples of such factors may include, but are not limited to, the technology used to implement the physical storage units and whether the mass storage device 828 is characterized as primary or secondary storage and the like.

For example, the computing device 800 may store information to the mass storage device 828 by issuing instructions through a storage controller 824 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 800 may further read information from the mass storage device 828 by detecting the physical states or characteristics of one or more particular locations within the physical storage units.

In addition to the mass storage device 828 described herein, the computing device 800 may have access to other computer-readable storage media to store and retrieve information, such as program modules, data structures, or other data. It should be appreciated by those skilled in the art that computer-readable storage media may be any available media that provides for the storage of non-transitory data and that may be accessed by the computing device 800.

By way of example and not limitation, computer-readable storage media may include volatile and non-volatile, transitory computer-readable storage media and non-transitory computer-readable storage media, and removable and non-removable media implemented in any method or technology. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage, other magnetic storage devices, or any other medium that may be used to store the desired information in a non-transitory fashion.

A mass storage device, such as the mass storage device 828 depicted in FIG. 8, may store an operating system utilized to control the operation of the computing device 800. The operating system may comprise a version of the LINUX operating system. The operating system may comprise a version of the WINDOWS SERVER operating system from the MICROSOFT Corporation. According to further aspects, the operating system may comprise a version of the UNIX operating system. Various mobile phone operating systems, such as IOS and ANDROID, may also be utilized. It should be appreciated that other operating systems may also be utilized. The mass storage device 828 may store other system or application programs and data utilized by the computing device 800.

The mass storage device 828 or other computer-readable storage media may also be encoded with computer-executable instructions, which, when loaded into the computing device 800, transforms the computing device from a general-purpose computing system into a special-purpose computer capable of implementing the aspects described herein. These computer-executable instructions transform the computing device 800 by specifying how the CPU(s) 804 transition between states, as described herein. The computing device 800 may have access to computer-readable storage media storing computer-executable instructions, which, when executed by the computing device 800, may perform the method described in relation to FIG. 7.

A computing device, such as the computing device 800 depicted in FIG. 8, may also include an input/output controller 832 for receiving and processing input from a number of input devices, such as a keyboard, a mouse, a touchpad, a touch screen, an electronic stylus, or other type of input device. Similarly, an input/output controller 832 may provide output to a display, such as a computer monitor, a flat-panel display, a digital projector, a printer, a plotter, or other type of output device. It will be appreciated that the computing device 800 may not include all of the components shown in FIG. 8, may include other components that are not explicitly shown in FIG. 8, or may utilize an architecture completely different than that shown in FIG. 8.

As described herein, a computing device may be a physical computing device, such as the computing device 800 of FIG. 8. A computing node may also include a virtual machine host process and one or more virtual machine instances. Computer-executable instructions may be executed by the physical hardware of a computing device indirectly through interpretation and/or execution of instructions stored and executed in the context of a virtual machine.

It is to be understood that the methods and systems described herein are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Components are described that may be used to perform the described methods and systems. When combinations, subsets, interactions, groups, etc., of these components are described, it is understood that while specific references to each of the various individual and collective combinations and permutations of these may not be explicitly described, each is specifically contemplated and described herein, for all methods and systems. This applies to all aspects of this application including, but not limited to, operations in described methods. Thus, if there are a variety of additional operations that may be performed it is understood that each of these additional operations may be performed with any specific embodiment or combination of embodiments of the described methods.

The present methods and systems may be understood more readily by reference to the following detailed description of preferred embodiments and the examples included therein and to the Figures and their descriptions.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described herein with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, may be implemented by computer program instructions. These computer program instructions may be loaded on a general-purpose computer, special-purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

The various features and processes described herein may be used independently of one another, or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto may be performed in other sequences that are appropriate. For example, described blocks or states may be performed in an order other than that specifically described, or multiple blocks or states may be combined in a single block or state. The example blocks or states may be performed in serial, in parallel, or in some other manner. Blocks or states may be added to or removed from the described example embodiments. The example systems and components described herein may be configured differently than described. For example, elements may be added to, removed from, or rearranged compared to the described example embodiments.

It will also be appreciated that various items are illustrated as being stored in memory or on storage while being used, and that these items or portions thereof may be transferred between memory and other storage devices for purposes of memory management and data integrity. Alternatively, in other embodiments, some or all of the software modules and/or systems may execute in memory on another device and communicate with the illustrated computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), etc. Some or all of the modules, systems, and data structures may also be stored (e.g., as software instructions or structured data) on a computer-readable medium, such as a hard disk, a memory, a network, or a portable media article to be read by an appropriate device or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the present invention may be practiced with other computer system configurations.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its operations be performed in a specific order. Accordingly, where a method claim does not actually recite an order to be followed by its operations or it is not otherwise specifically stated in the claims or descriptions that the operations are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

It will be apparent to those skilled in the art that various modifications and variations may be made without departing from the scope or spirit of the present disclosure. Other embodiments will be apparent to those skilled in the art from consideration of the specification and practices described herein. It is intended that the specification and example figures be considered as exemplary only, with a true scope and spirit being indicated by the following claims.

1. A method comprising:
receiving, from a computing device, a request to store content associated with a recording;
generating, based on the request, data comprising a common segment of the content that is common to a plurality of users and information associated with a user-specific segment of the content associated with a user of the plurality of users, wherein the information is usable to recreate the user-specific segment of the content;
receiving, from the computing device, a request to access the content, wherein the request is associated with the user; and
sending, based on the request to access the content, the information to enable the computing device to output the data.

2-3. (canceled)

4. The method of claim 1, wherein the data comprises a content segment group file associated with a replication job for the replication of the stored content.

5. (canceled)

6. The method of claim 1, wherein the information is stored within a header and wherein the information is encrypted.

7. The method of claim 6, wherein a private key is used to decrypt the information.

8. The method of claim 1, wherein the data is sent to a storage system comprising at least one of a low access speed spinning drive or low access speed cloud drive.

9. The method of claim 1, wherein the sending causes playback of the recording.

10-20. (canceled)

21. The method of claim 1, wherein the common segment of the content is stored in a cold storage system comprising at least one of a low access speed spinning drive or low access speed cloud drive.

22. The method of claim 6, wherein the header is stored in a hot storage system comprising at least one of a solid state drive or a flash drive.

23. A device comprising:
one or more processors; and
memory storing instructions that, when executed by the one or more processors, cause the device to:
receive, from a computing device, a request to store content associated with a recording;
generate, based on the request, data comprising a common segment of the content that is common to a plurality of users and information associated with a user-specific segment of the content associated with a user of the plurality of users, wherein the information is usable to recreate the user-specific segment of the content;
receive, from the computing device, a request to access the content, wherein the request is associated with the user; and
send, based on the request to access the content, the information to enable the computing device to output the data.

24. The device of claim 23, wherein the data comprises a content segment group file associated with a replication job for the replication of the stored content.

25. The device of claim 23, wherein the information is stored within a header and wherein the information is encrypted.

26. The device of claim 25, wherein a private key is used to decrypt the information.

27. The device of claim 25, wherein the header is stored in a hot storage system comprising at least one of a solid state drive or a flash drive.

28. The device of claim 23, wherein the data is sent to a storage system comprising at least one of a low access speed spinning drive or low access speed cloud drive.

29. The device of claim 23, wherein the sending causes playback of the recording.

30. The device of claim 23, wherein the common segment of the content is stored in a cold storage system comprising at least one of a low access speed spinning drive or low access speed cloud drive.

31. A non-transitory computer-readable medium storing instructions that, when executed, cause:
receiving, from a computing device, a request to store content associated with a recording;
generating, based on the request, data comprising a common segment of the content that is common to a plurality of users and information associated with a user-specific segment of the content associated with a user of the plurality of users, wherein the information is usable to recreate the user-specific segment of the content;
receiving, from the computing device, a request to access the content, wherein the request is associated with the user; and
sending, based on the request to access the content, the information to enable the computing device to output the data.

32. The non-transitory computer-readable medium of claim 31, wherein the data comprises a content segment group file associated with a replication job for the replication of the stored content.

33. The non-transitory computer-readable medium of claim 31, wherein the information is stored within a header and wherein the information is encrypted.

34. The non-transitory computer-readable medium of claim 33, wherein a private key is used to decrypt the information.
